(19) United States
(12) Patent Application Publication
(10) Pub. No.: US 2011/0029895 A1
(43) Pub. Date: Feb. 3, 2011

(54) SYSTEM AND METHOD FOR CONDUCTING ON-LINE RESEARCH

(75) Inventor: Adrian Ternouth, Queensland (AU)

Correspondence Address: Baker Donelson Bearman, Caldwell & Berkowitz, PC, 920 Massachusetts Ave, NW, Suite 900, Washington, DC, 20001, US

(73) Assignee: Adrian Ternouth, Brisbane, Queensland (AU)

(21) Appl. No.: 12/934,599

(22) PCT Filed: Mar. 30, 2009
(86) PCT No.: PCT/AU2009/000383

§ 371 Date: Oct. 15, 2010

(30) Foreign Application Priority Data
Mar. 28, 2008 (AU) 2008901492

(51) Int. Cl. G06F 3/01; G06F 15/16

(52) U.S. Cl. 715/753

(57) ABSTRACT

A method and system enables improved on-line research involving identification of associations generated by a server in response to input received from a multi-user problem group. The method includes processing user details received from a plurality of users in the multi-user problem group (step A). Fixed and rotating questions are then received and transmitted to the problem group, and answers to the fixed and rotating questions are then processed by the server (steps B to G). An identification of at least one association based on the user details, the answers to the at least one fixed question, and the answers to the at least one rotating question, is then automatically generated by the server (step H). Finally, the identification of the at least one association is transmitted to a user (step I).

### FIELD OF THE INVENTION

The present invention relates generally to online research, and in particular, although not exclusively, the present invention relates to a system and method for allowing a multi-user problem group to self direct its own online research, including the identification of associations among data collected by that multi-user problem group.

### BACKGROUND TO THE INVENTION

Medical advances and improvements in general public health have progressed immensely in the past century. At the turn of the 20^{th} Century the average life expectancy in Australia was about 57. In 2005, the average life expectancy in Australia was about 80. That is due in part to the amount of medical research that has been conducted into finding causes of and best treatments for diseases.

Many epidemiology research projects are designed to gather statistical data to establish possible associations concerning diseases. For example, such associations may concern incidents of cancer among people living next to high voltage powerlines. Due in part to formal research projects, such associations have for example been established between smoking and various health issues. Although it is well known that such associations do not necessarily imply causation, identifying such associations is often an important first step in understanding a causal mechanism of disease. In addition, the serial tracking of treatments and their outcomes prospectively can identify associations that are very likely causal relationships, as opposed to where single measures alone are used.

However, setting up an epidemiology research project to detect associations concerning a disease or other medical condition is often expensive, time consuming and inflexible. Further, many research projects are limited to specific geographical areas or to a certain number of people due to cost restraints. Project results thus may be statistically inconclusive due to a small number of participants.

Understandably, people with medical conditions often take a great interest in the causes of their condition. And they may ask many questions, for which there are often no answers. However, sufferers of disease have historically been involved with medical research primarily as subjects of study, and not as active architects of research. Their motivation to help themselves and their intellectual powers are wasted as they have no outlet. Rather, the designing of a research project awaits interest from and is often controlled only by a limited number of professionals. This number is limited relative to the number of questions that need answering. In addition there is only very limited input of creative questioning, research thinking and problem solving by those living with a medical condition. There is therefore a need for an improved system and method for conducting medical research that is more flexible and cost effective than the prior art and in particular one that enables that extremely large group of people who are not trained researchers to nonetheless contribute to furthering research.

### OBJECTS OF THE INVENTION

It is an object of the present invention to overcome and/or alleviate one or more of the above disadvantages of the prior art, or provide the consumer with a useful or commercial alternative.

### SUMMARY OF THE INVENTION

According to one aspect, the invention is a system for conducting on-line research involving identification of associations among data self generated by a multi-user problem group. According to some embodiments of the present invention, such a system may comprise:

a server processor; and

a server memory coupled to the server processor, wherein the server memory includes computer readable program code components configured to cause:
processing user details received from a plurality of users in the multi-user problem group;
processing at least one fixed question, generated by a user in the plurality of users, relevant to a problem addressed by the problem group;
transmitting to the plurality of users the at least one fixed question;
processing answers to the at least one fixed question received from users in the plurality of users;
processing at least one rotating question generated by a user in the plurality of users;
transmitting to the plurality of users the at least one rotating question;
processing answers to the at least one rotating question received from users in the plurality of users; and
automatically generating an identification of at least one association based on the user details, the answers to the at least one fixed question, and the answers to the at least one rotating question.

Optionally, the identification of the at least one association is generated automatically by the server using statistical analysis.

Optionally, the plurality of users in the multi-user problem group is operatively connected to the server via the Internet.

Optionally, processing the at least one fixed question comprises enabling the plurality of users to vote on whether the fixed question is appropriate for the problem group.

Optionally, processing the at least one rotating question comprises enabling the plurality of users to vote on whether the rotating question is appropriate for the problem group.

Optionally, the user details comprise a user name, a date of birth, an email address, and a geographical indicator.

Optionally, a user earns credit for providing an answer to a fixed question or providing an answer to a rotating question.

Optionally, the at least one fixed or rotating question is authored by an expert in a field of the problem addressed by the problem group.

Optionally, the memory further comprises computer readable program code components configured to cause transmitting and analysing answers to private questions submitted by a user that are not shared with the multi-user problem group.

Optionally, the memory further comprises computer readable program code components configured to cause transmitting to a user in the multi-user problem group the identification of the at least one association.

Optionally, the memory further comprises computer readable program code components configured to cause:

processing at least one control question generated by the multi-user problem group functioning as a primary multi-user problem group, and answered by a second multi-user problem group functioning as a control multi-user problem group.

Optionally, the problem addressed by the multi-user problem group concerns epidemiology.

According to another aspect, the present invention comprises a method for conducting on-line research involving identification of associations generated by a server in response to input received from a multi-user problem group, the method comprising:

processing user details received from a plurality of users in the multi-user problem group;

processing at least one fixed question, generated by a user in the plurality of users, relevant to a problem addressed by the problem group;

transmitting to the plurality of users the at least one fixed question;

processing answers to the at least one fixed question received from users in the plurality of users;

processing at least one rotating question generated by a user in the plurality of users;

transmitting to the plurality of users the at least one rotating question;

processing answers to the at least one rotating question received from users in the plurality of users; and

automatically generating an identification of at least one association based on the user details, the answers to the at least one fixed question, and the answers to the at least one rotating question.

### BRIEF DESCRIPTION OF THE DRAWINGS

By way of example only, preferred embodiments of the invention will be described more fully hereinafter with reference to the accompanying figures, wherein:

FIG. 1 is a block diagram showing a system for conducting on-line research, according to some embodiments of the present invention.

FIG. 2 is a flow diagram illustrating how a particular medical problem can be addressed by conventional research intelligence and expert skills, and simultaneously supplemented by research of motivated and intelligent non-experts guided by a system and method of the present invention.

FIG. 3 is a flow diagram illustrating a simplified method of how a group of people with a medical problem “X” can employ the teachings of the present invention to obtain clues, solutions, improvements, or even cures to the medical problem “X”.

FIG. 4 is a general state diagram illustrating an optionally cyclical process of obtaining associations relevant to a particular multi-user problem group, according to some embodiments of the present invention.

FIG. 5 is a flow diagram illustrating a process of asking “rotating questions” to a multi-user problem group, according to some embodiments of the present invention

FIG. 6 is a high level flow diagram showing stages (which do not have to be necessarily conducted in the order shown) of conducting on-line research, according to some embodiments of the present invention.

FIG. 7 is a screen shot of a web page showing a login screen according to an embodiment of the present invention.

FIG. 8 is a screen shot of a main web page showing various options available to the user, including interactions with different problem groups.

FIG. 9 is a screen shot of a web page that allows the user to edit user details.

FIG. 10 is a screen shot of a web page that allows the user to join a problem group.

FIG. 11 is a screen shot of a web page that allows the user to create a new problem group.

FIG. 12 is a screen shot of a web page that requests confirmation for the addition of the user to the new problem group.

FIG. 13 is a screen shot of a web page where a user can view, answer and update fixed questions concerning a problem.

FIG. 14 is a screen shot of a web page where the user may answer rotating questions relating to a particular problem.

FIG. 15 is a screen shot of a web page that allows the user to propose a research question.

FIG. 16 is a screen shot of a web page that allows users to vote on proposed research questions.

FIG. 17 is a screen shot of a web page that allows users to search for statistical relationships in the data collected by the group.

FIG. 18 is a screen shot of a web page that enables display of answers to fixed questions and answers to rotating questions.

FIG. 19 is a screen shot of a web page that allows the user to view a number of credits he or she has earned, used or purchased.

FIG. 20 is a screen shot of a web page that explains what the answers to the fixed questions and the answers to the rotating questions may mean.

FIG. 21 is a screen shot of a web page explaining how to use the information displayed by the system and method for conducting on-line research.

### DETAILED DESCRIPTION OF THE PREFERRED EMBODIMENT

At this time in history, lots of apparently very basic facts are either unknown or only just being learnt about diseases, treatments and situations in peoples' lives, where if society had known them before now, it would have been beneficial. For example, the simple act of lying babies on their backs at night rather than prone, has caused almost a disappearance in SIDS deaths, but an association between SIDS and sleeping position was not discovered until about a decade ago. Also, recent meta-analyses suggest that the profligate use of Prozac like drugs is wasteful and dangerous, since these drugs only work well in the more severely depressed and have no extra effect over a placebo plus exercise for the rest. The only proven effects of Prozac in those who are not benefiting from it are side effects. But facts such as these often come to light only fortuitously, and because a particular researcher has decided to make it the focus of enquiry.

Given present systems of organized research, the most motivated people, who are most interested in finding out about how best to manage/prevent/fix a situation or disease—namely, the people who suffer its consequences—are highly unlikely, despite their drive, to make any contribution to finding a solution.

The present invention as described herein enables automatic harnessing of the energy of those who are motivated to find out about given diseases, and enables people to shed light on associations that may never otherwise be found. Embodiments of the present invention enable the non-scientifically knowledgeable general population to progress the understanding of their own diseases and health problems to the point where specific new and useful information comes to light. That information can then result in better treatments that may otherwise never be found.

According to some embodiments, the present invention is a system for automatically organizing a group of people, who generally do not have professional training, to self-generate their own research into a disease or situation that they are affected by and or interested in. The system will allow the people most interested in a disease, and who live it most dramatically (i.e., those directly affected by it), to work proactively and collaboratively toward identifying relevant associations and ultimately “solving” elements of a given disease's complexities, without needing to wait for some professional researcher affiliated with some group to come along and do similar research work.

According to some embodiments of the present invention, individuals who have a focus on a disease or situation in their lives (and want to know more about it) join an on-line group that shares that characteristic. Each time they use/visit a system web site they can do any of four things. They can answer research questions, propose research questions, vote on the questions that the group wants researched next, and finally they can review data that have been collected and generated (looking for new associations or information of use to the group and themselves).

Questions can be somewhat different for each focus group, but generally can be of four types. First, there are basic disease/situation gathering questions that are generally asked once and whose answers usually do not change (e.g., what is your name, where do you live, how was your diagnosis made and by whom?). Second, there are fixed questions that are asked repeatedly of each user at sequential times (e.g., perhaps each time a user logs on to the system, or perhaps once a year depending on the question). Third, there are a number of rotating questions, which have been generated by the focus group, for the group to answer (e.g., if the group is wondering how much exercise other group members do). These questions are asked once of a sufficient number of members of the primary group to gain a certain sized sample. Fourth, a number of rotating questions that originate from other groups are asked, so that a user may be a ‘control’ for that other group which is focussed on another disease/situation. In this fourth type of question, the individual answering the question is serving as a ‘control’ for the other group's research objective, allowing that other group to see what the background frequency is in people who don't have their disease/situation (e.g., how much, on average, people who don't have their disease do physical exercise, so that a comparison can be made to how much physical exercise people within their group do). Once again these types of control rotating questions are asked once of members of other groups, until a sufficient sample size is gained. Associations may be found within and between any combination of the questions and active and control groups. For example there will be an association that is obvious between age and the diagnosis of dementia. There may be an association found between fixed questions of amount of exercise and subsequent change in high blood pressure severity. There might be found a positive correlation between lying babies face down and SIDS deaths compared to ‘control’ babies who have random other medical problems which the site is helping with.

The result of asking the questions is that the system gathers data for the groups to analyse. The data is made available to the groups, allowing members to examine their research outcomes. For example users might, after answering questions, see that those who have high blood pressure actually exercise less, and that the more they exercise, the lower their blood pressure is.

The third and fourth types of questions are both a ‘rotating’ type of question, in that they are asked a certain number of times, and are then rotated from the ‘active list of questions’, being replaced by new questions rotating into their place. New ‘proposed’ fixed and rotating questions are generated by individuals in the group with the help of prompts at the website, in a guided way. The group then votes on which proposed questions the group will add to the list of active rotating questions next and how many people need to complete the question within the group and separately, as controls. Less frequently a new fixed question will be proposed and voted on, and possibly added to that repeatedly asked question list (fixed questions are asked repeatedly of the members of a given problem group and so members are less likely to be keen on having questions added to that list). The system will then aid users to manually generate, and to some degree automatically generate, searches for statistically significant findings in the data collected. For example statistically significant differences may be found between the focus group and other groups in the area of ‘amount of exercise’. Alternatively, significant differences may be found between the location, or treatment user data and outcomes for a given disease (e.g., the French might cure bowel cancer with some new treatment that no-one else has). The members can continue to make meaningful increases in sum data surrounding their disease or situation—hopefully finally resulting in better quality of life for the group with the disease/situation. Guided, manual and automatic searches of increasingly more complex combinations of factors, looking for statistically significant results, will become available as the site progresses.

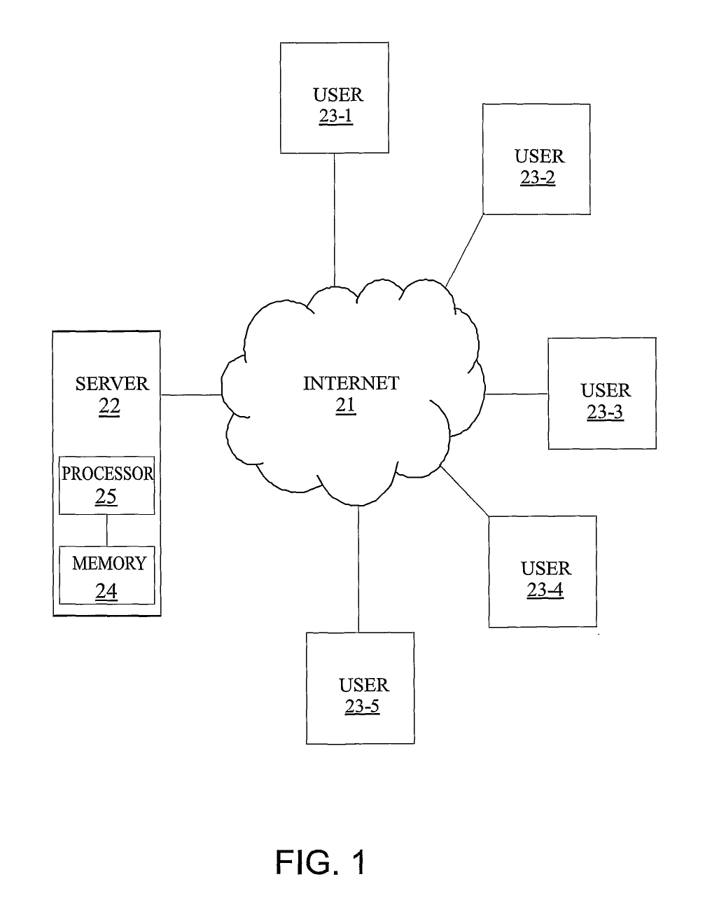

FIG. 1 is a block diagram showing a system for conducting on-line research, according to some embodiments of the present invention. A computer in the form of a server 22 is connected to the internet 21, to which users 23-n have access. Users 23-n may access the server 22 using a web browser, as known by persons having ordinary skill in the art. The server 22 comprises computer readable program code components in the form of software installed on a memory 24, for example on a hard disk, a random access memory (RAM), or any other applicable computer readable medium. The computer readable program code components are then processed by a server processor 25 and are configured to cause execution of a method of the present invention.

The server 22 thus may function as a system for assisting a non expert group in automatically conducting their own on-line research without the need for a professional researcher. The research system allows the plurality of users 23-n to participate in research concerning a particular problem or situation by answering questions that are authored by other users 23-n in a particular field of interest. The users 23-n are people who may have a common problem in a particular field, work in the particular field, perform research in the particular field or have a general interest in the particular field. In one embodiment of the present invention the problem area relates to medical conditions. However it is envisaged that other embodiments of the present invention may, for example, enable investigation into any problem area, such as faults developed in vehicles, or situations where no problem per se exists but improvements may nevertheless be made (e.g., a group that is interested in an exercise type such as running, or that races vintage cars).

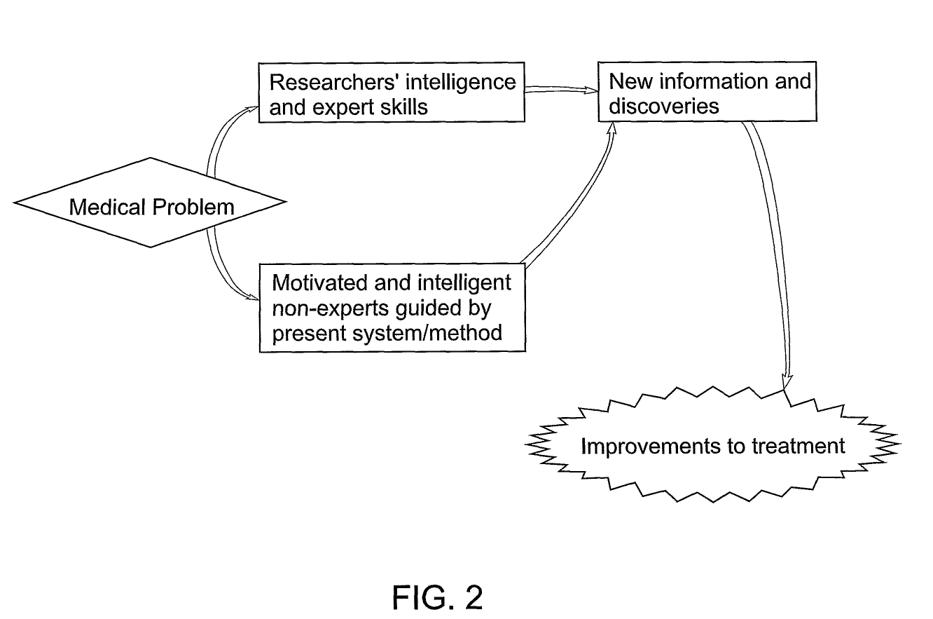

FIG. 2 is a flow diagram illustrating how a particular medical problem can be addressed by conventional research intelligence and expert skills, and simultaneously supplemented by research of motivated and intelligent non-experts guided by a system and method of the present invention.

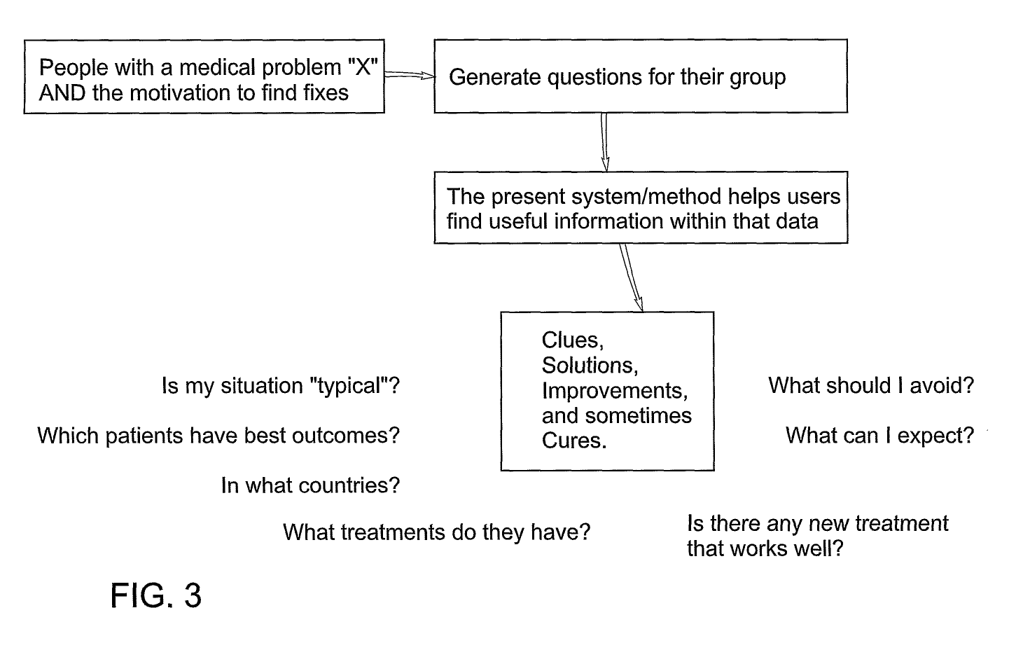

FIG. 3 is a flow diagram illustrating a simplified method of how a group of people with a medical problem “X” can employ the teachings of the present invention to obtain clues, solutions, improvements, or even cures to the medical problem “X”.

In this specification, the phrase “multi-user problem group” thus refers to any group of on-line participants that seeks information about a problem or situation. The term “problem” is used to refer to any problem or situation of interest to a group. Thus multi-user problem groups can be formed to address problems or situations in almost any field, medical or non-medical. Further, the term “association” is used to refer to any relationship or statistically significant function between data elements submitted to the system. Various likelihoods of causality are able to be found—for example if a fixed question is asked of people after they start a new treatment, in a prospective manner, the likelihood of the outcome, good or bad, being specifically causally affected by the treatment, is higher.

Each macro problem area can be divided into specific problem groups for users to join. For example, in the medical field groups may be related to back ache, blood pressure, bowel cancer, breast cancer, lung cancer (and its subtypes), dementia (and its subtypes) and almost any other type of medical ailment.

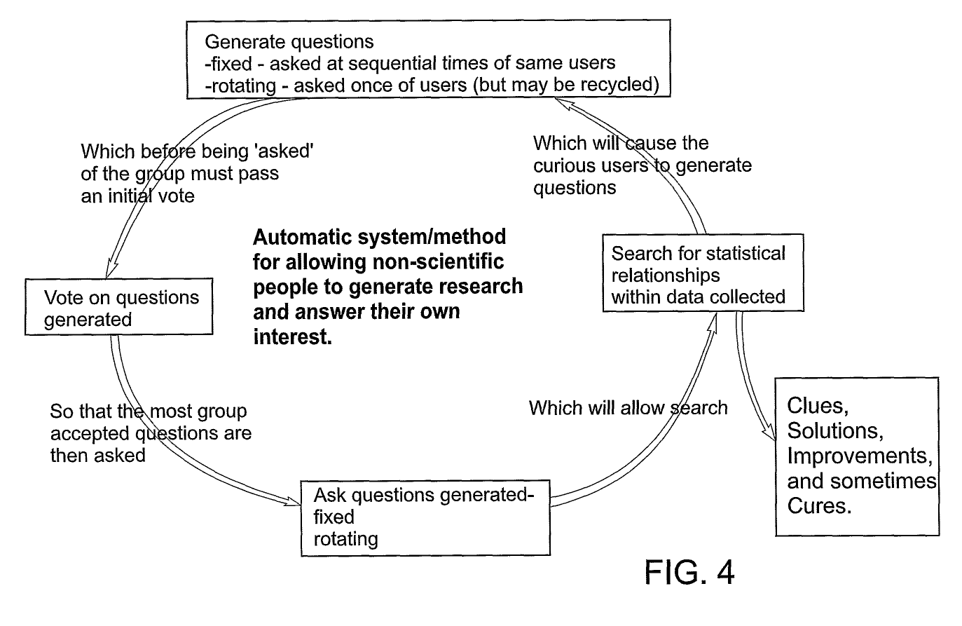

FIG. 4 is a general state diagram illustrating a cyclical process of obtaining associations relevant to a particular multi-user problem group, according to some embodiments of the present invention. As shown, fixed and rotating questions can be generated by users and proposed to the group. The users then vote on whether proposed questions are relevant and/or appropriate. Questions that receive an acceptable number of votes are then asked of the users. The users' responses to the asked questions then can be searched, manually or automatically, to generate identifications of associations or statistically relevant relationships among available data. In many cases, identified associations will then cause the users to generate additional proposed questions for the group, which causes the cyclical process to repeat. Useful information concerning problems can be thoroughly researched by iterative execution of the various states of FIG. 4, and answers to questions may result in a statistical convergence of associations that are relevant to understanding causal mechanisms about a particular problem. Thus, as shown, clues, solutions, improvements, or even cures concerning the problems can be extracted from the associations.

Some further definitions are provided as follows. An active list of questions includes questions that are currently being asked of users. A proposed list of questions includes questions that are proposed by users but not presently asked of users, because for example there is not yet sufficient consensus or there is not adequate space on the active list of questions. A primary group refers to a group that is primarily referred to. For example, if a discussion concerns a group that has blood pressure problems, then the primary group refers to that group and “other groups” refers to groups other than the blood pressure group—for example the bowel cancer group.

A fixed question is a question which is asked of each user in the primary group repeatedly. Each group generally has different fixed questions, since different problems have different markers of ongoing significance. An example includes users in the “blood pressure problems” group being asked what their blood pressure is and what treatment they are having. Different fixed questions would be asked with different intervening time intervals depending on their nature. Fixed questions are first defined at the time a group is created, and then modified by group voting. Unlike rotating questions, they are not ‘rotated out’ of an active list after being asked a certain number of times.

A rotating question is one which is generated by a primary group, asked of that primary group a certain number of times before being “retired”, and usually asked also of other groups as controls for the primary group, For example a group interested in childhood asthma might wonder whether asthma is associated with the position their children sleep in. Therefore the question “on which side does your baby sleep” may be asked of 100 users in the group, and of 50 users in various other groups whose members also have a child, but where the children of the other groups do not suffer from childhood asthma. After the question has been asked of 100 users in the asthma group and 50 users in other groups, the question is removed from the “active” list, as a sufficient statistical sample has been gained. At that point, the “active questions list” is updated using the list of proposed questions. The number of times that a question is asked of the primary and other groups (as a control) depends on how large of a sample size the group is interested in searching for. The system guides voting by users based on how many people are required for a given statistical significance to be reliably detected within a sample. For example, if the expected effect of a treatment is that it will halve the incidence of a certain disease complication, where that complication happens in almost everyone with the disease, then the system recommended sample size would be smaller than if the effect of a treatment would be to decrease the incidence of that complication by only 5%.

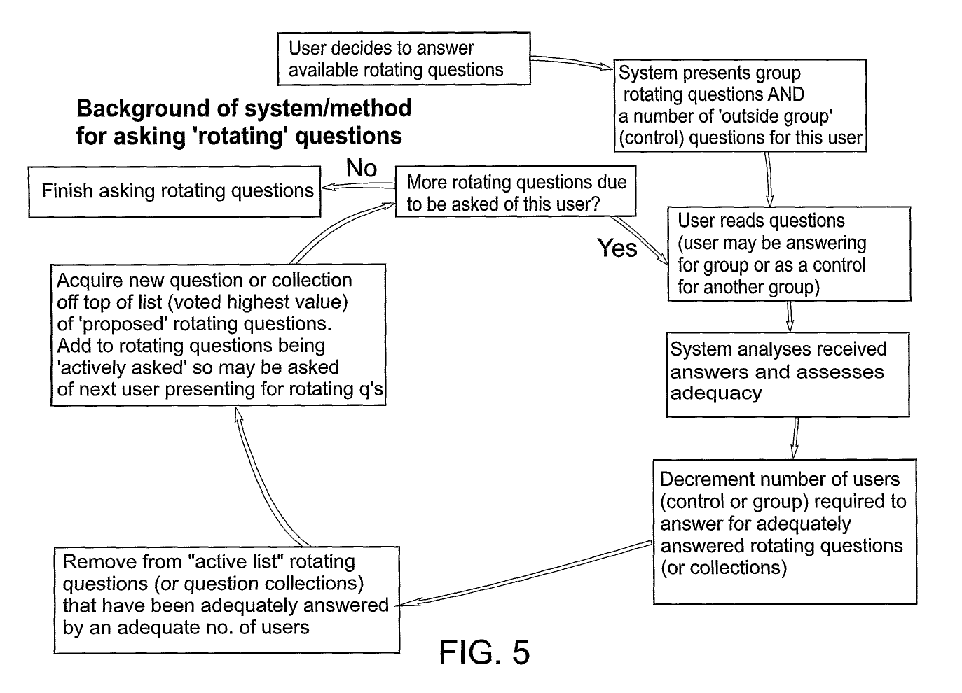

FIG. 5 is a flow diagram illustrating a process of asking “rotating questions” to a multi-user problem group, according to some embodiments of the present invention. First, a user decides to answer available rotating questions. The system then presents to the user a number of group rotating questions and a number of “outside group” (control) rotating questions (either individually or grouped). The user then reads a question and answers it. The user may answer all the questions or submit them serially. Either way, for each answer, the system analyses a received answer and determines whether it can be used. If an answer cannot be used, for example because the user's answer was somehow inadequate or because the user responded that he or she was unable to answer a question, then the system determines that the question should be asked of another user, and the system also determines whether additional rotating questions should be asked of the present user.

However, if the user's answer to a particular rotating question is determined by the system to be acceptable, then the system decrements the number of users (from a control group or from the present problem group) who still need to be asked that particular rotating question. In addition, it is determined whether the particular question still needs to be asked of other control or group users. When the question has been asked of a sufficient number of users in group and non group cases, then the particular question is removed from a list of rotating questions that are being “actively asked” of the present problem group or an outside group. After a question is removed from the list of rotating questions that are being actively asked, then a new question is immediately added to the list from the lists of proposed questions that each group has. The question added is the one that has received a high number of votes from users. It is then determined whether additional questions need to be asked of the present user.

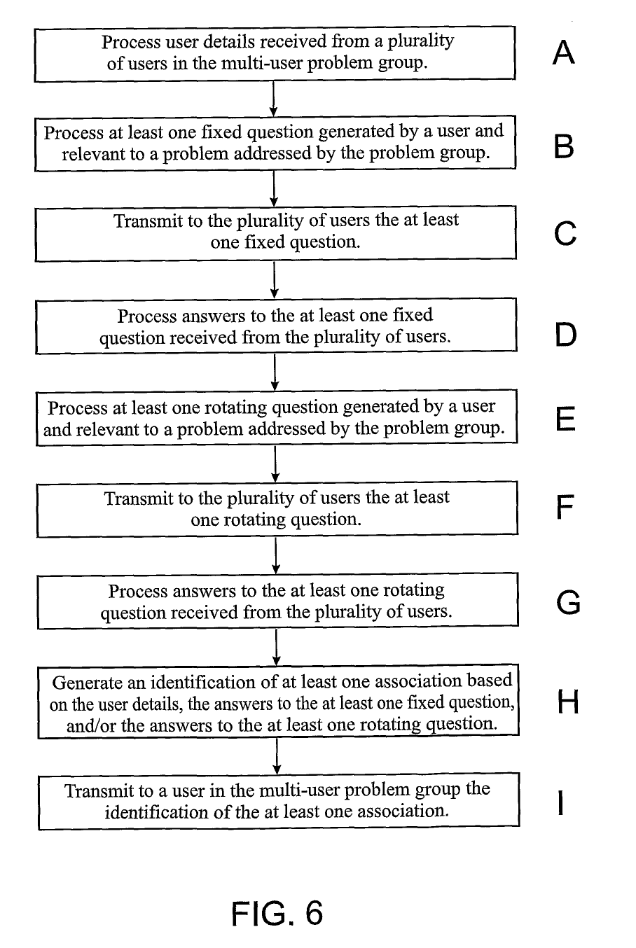

By a voting process, users are thus able to “self-regulate” a problem group so that users are not overwhelmed by too many questions, or discouraged by confusing, unhelpful, or otherwise inappropriate questions. As described in more detail below, such a voting process can also include mandatory grouping of questions, and weighting of votes based on a user's background or experience. FIG. 6 is a high level flow diagram showing process steps in a research system embodied in a web server 22, according to some embodiments of the present invention. At step A, the research system processes user details received from a plurality of users 23-n in a multi-user problem group. User details may include, for example, a user name, a date of birth, an email address and a geographical indicator. A geographical indicator can be a useful indicator of a person's location, without necessarily providing an exact address, which of course many users are understandably not willing to disclose. Examples include recording a country, state, metropolitan region, nearest city or distance from a city centre.

At step B the research system processes at least one fixed question generated by a user 23-n in the plurality of users 23-n, where the question is relevant to a problem addressed by the problem group. Processing the at least one fixed question generally comprises receiving the question in an electronic communication and storing the question in a memory operatively connected to the server 22.

At step C the research system transmits to the plurality of users 23-n the at least one fixed question. At step D, the research system processes answers to the at least one fixed question received from the plurality of users 23-n. The fixed questions, for example blood pressure, can be updated periodically to provide statistical trends for the user 23-n over time.

At step E, the research system processes (by receiving and storing) at least one rotating question generated by a user 23-n in the plurality of users 23-n and relevant to a problem addressed by the problem group. At step F, the research system transmits the at least one rotating question to the other users 23-n in the plurality of users 23-n. At step G, the research system processes answers to the at least one rotating question. Rotating questions may be sent to one group within a problem area or to many groups within a problem area.

Rotating questions may be re-presented for the group after a period of time, should a second measurement of a characteristic be of interest to the group.

Also, either fixed or rotating questions may be sent as a collection. When two or more questions form a collection, they are generally asked together, voted on by the group together, and added to the list of questions, or rejected by the group, together. For example, a first question may be “Do you have a child?” and a second question affiliated with the first may be “If so, what is his or her age?”. The second question makes sense only if it follows the first question, and thus the two questions would be proposed, voted on, and asked as a collection.

At step H, the research system automatically generates an identification of at least one association based on the user details, the answers to the at least one fixed question, and the answers to the at least one rotating question. Finally at step I, the server 22 transmits to the user 23-n in the multi-user problem group the identification of at least one association. For example, an association may be displayed to a user 23-n in the form of a table, a graph or chart, or as text describing the association. According to some embodiments of the present invention, generation of the identification of an association can be performed automatically based on a statistical computer analysis of available answers to questions relevant to a problem group. Alternatively, the members of a group can be guided by the system to perform allowed searches of data so that they identify relevant statistical relationships themselves. Also, generation of an identification of an association can be performed using a combination of automatic statistical analysis and professional human oversight by a professional who monitors answers submitted by a group. Further, according to some embodiments, the server 22 can self instigate its own searches for associations and correlations within data or respond to specific inquiries by users. For example, the server 22 may be directed to find associations between three different questions that were already asked, and such associations will then automatically be calculated and returned to the users.

FIG. 6 shows the steps happening sequentially, which is not necessary, and it is recognised that the events may be performed by users in almost any order, and some steps can be skipped entirely. For example, users may wish simply to log on and do step H—looking for useful information amongst already generated data.

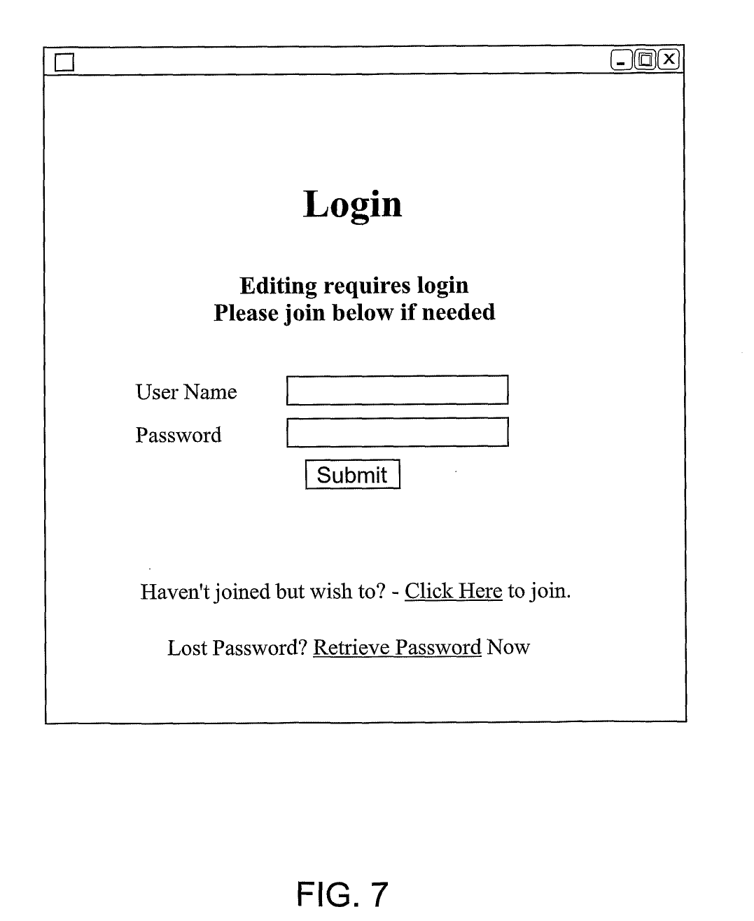

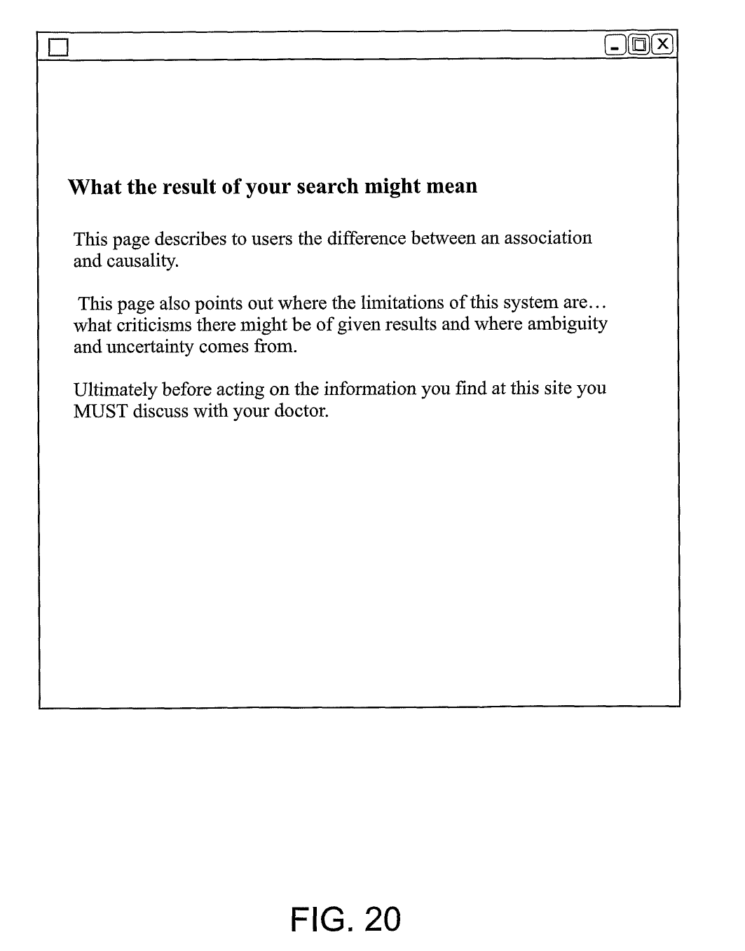

Below is a detailed description of FIGS. 7-21, which comprise conceptual screen shots that illustrate a general architecture of a web site hosted by the server 22, according to some embodiments of the present invention.

FIG. 7 is a screen shot of a web page showing a login screen, according to an embodiment of the present invention. A user 23-n provides a user name and a password in order to log into the system. If the user 23-n has not registered he or she can enter a registration page by clicking a “click here” button.

As will be understood by those having ordinary skill in the art, a login screen can be important to ensure the privacy of users, and to ensure that a system according to the present invention is not abused by automatic “web crawlers” or other software devices. Thus an appropriate login screen may include other safeguards, such as distorted text imagery or audio challenges, used to detect whether a user is a human or a computer.

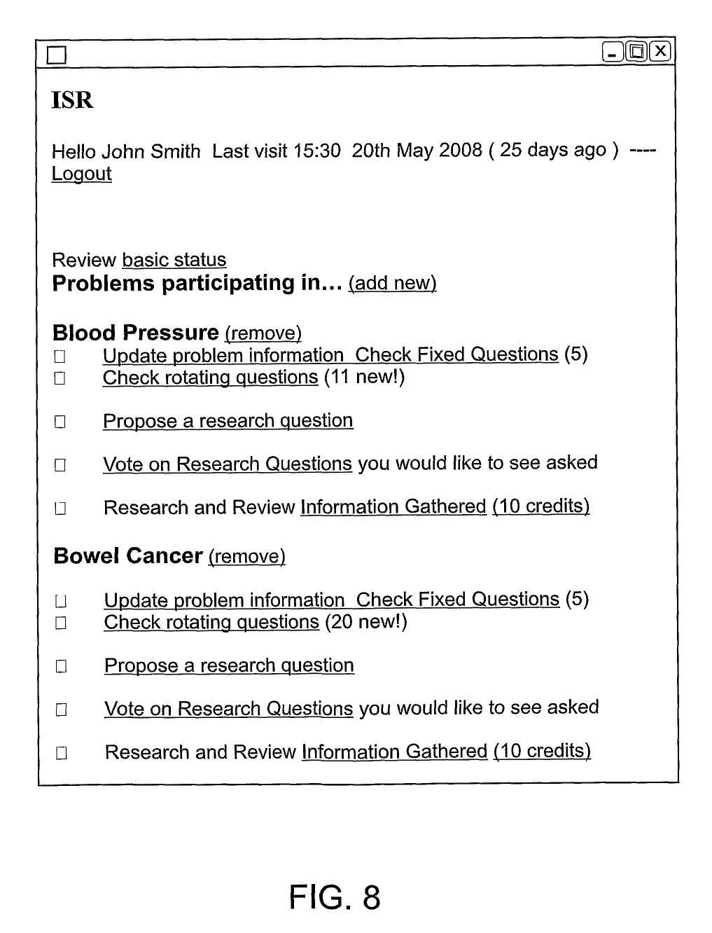

FIG. 8 is a screen shot of a main menu web page showing various options available to the user 23-n. From this page, the user 23-n can review his or her user details, join new problem groups, remove themselves from problem groups, contact a group moderator, review or answer fixed questions, review or answer rotating questions, propose research questions, vote on research question proposals, and review answers to fixed questions and answers to rotating questions received from the group. Additional selections may include, for example, discussion boards, instigating randomised controlled studies, and prize pools for achievements in problem areas. For example, FIG. 8 shows that a current user 23-n is participating in both a Blood Pressure problem group and a Bowel Cancer problem group.

While some advantages exist for having all options available on this first logged in page, it may be the case that a web site according to the present invention evolves to having problem groups having their own pages or a combination.

According to some embodiments of the present invention, each group will have at least one moderator. Web sites according to some embodiments may be automated as much as possible so that there is no need for a moderator's interference. However, in many cases the use of moderators may be very helpful. For example, each user may when signing up to a group also provide his or her areas of expertise. Other users can then appoint a moderator based on provided details. The person who becomes a moderator for any particular block of time (e.g., 3 months) will be the one who has agreed to be happy to be a moderator, and has a high value when using the following formula: Moderator TOTAL=votes by other users*constant1+value of moderator's own vote*constant2. Where Constant 1 and Constant 2 may be varied by a combination of activities at the site and administrators of the site so that there is reasonable weight given to both the user's online reputation at the site and the relevant group's decision.

A main menu web page may also include links to a discussion page. For example, such a discussion page can be set up as a “wiki” to provide relevant background information to newcomers to a group, or can be used as an informal chat area where potential questions and issues are addressed. Further, pop-up windows can be used to assist users in brainstorming about particular issues.

Further, a main menu web page may include various other features such as the ability of users to propose prizes or awards for achievement of a particular goal, such as the identification of a particular association. Such prizes or awards may effectively incentivize and motivate other users to join groups and to work diligently on solving particular problems or researching particular areas. According to some embodiments, group sponsors also may be used to provide incentives for users to join a group that initially has low participation numbers. Such incentives may include, for example, gift vouchers or random prize drawings.

Chat functionality can be added on a group by group basis so that members that are online, and involved in particular groups, may interact with each other in real time.

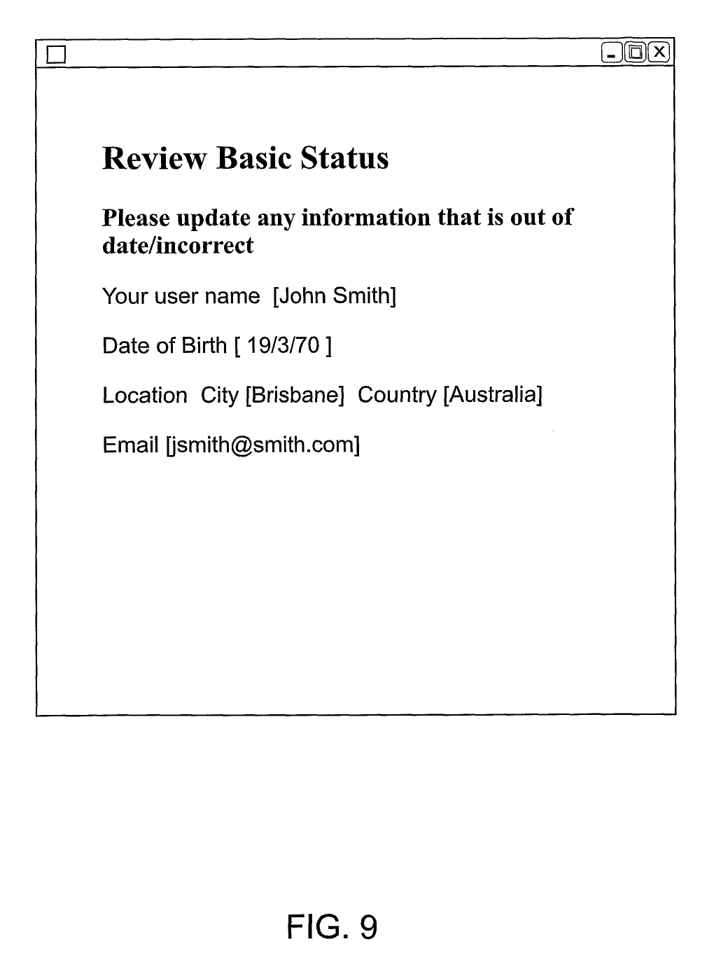

FIG. 9 is a screen shot of a web page that allows the user 23-n to review, edit or input general data. Other general data entries may include, but are not limited to:
Set an inactivity period so that after a period of time of no activity the user 23-n is deleted from the on-line research system's database.
Set an email address to send a forgotten password.
Allow a moderator to check the identity of researchers in areas of expertise so that a value can be placed on input provided by that researcher.
Notify the user 23-n of research projects.
Allow the user 23-n to set a maximum number of research questions to answer.
A user's expertise level and third party comments or verifications concerning a user's expertise.

Other data that is reviewable by a user may include a value of his or her vote in a particular problem group relative to other users. For example, when a user votes for a question that has been proposed, that question's value rises. However, all users' votes may not have an equal value. A user's vote value may change over time depending on various factors, including:
amount of time that a user has been a member of a group;
amount of participation in answering questions;
questions a user has proposed and whether they get voted up to the ‘asking’ stage; and
administrative review concerning whether a user is constructively participating in a group forum.

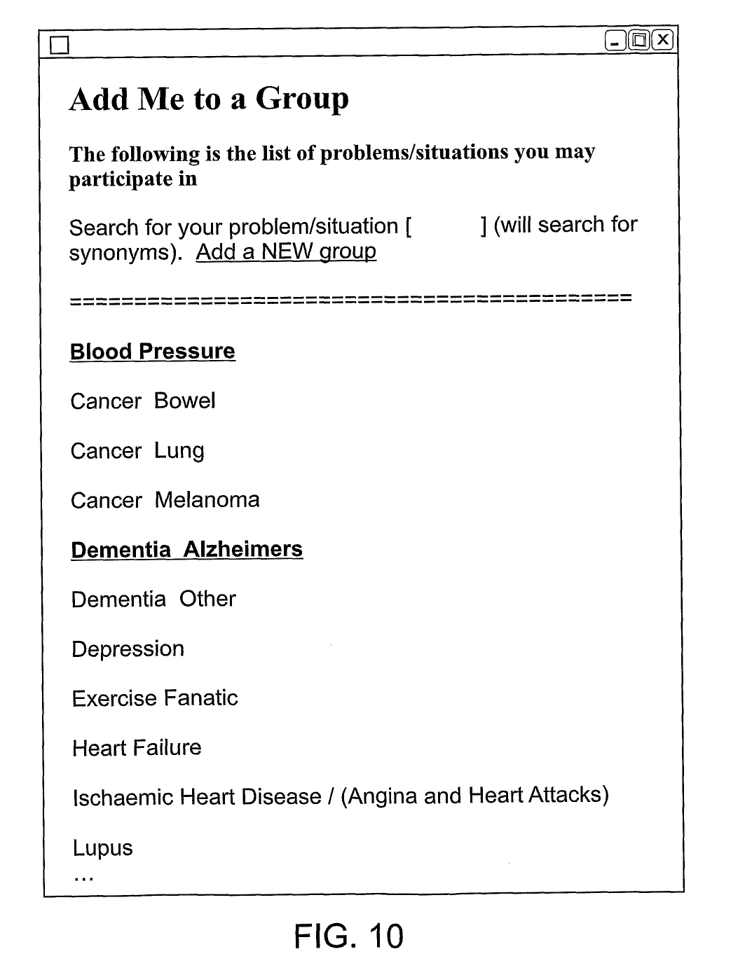

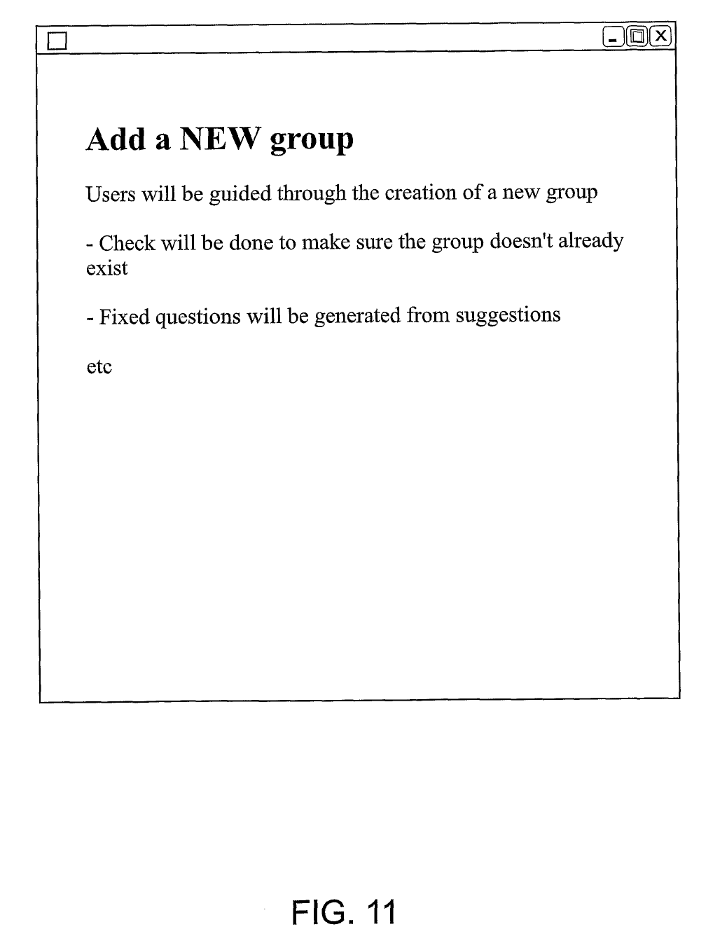

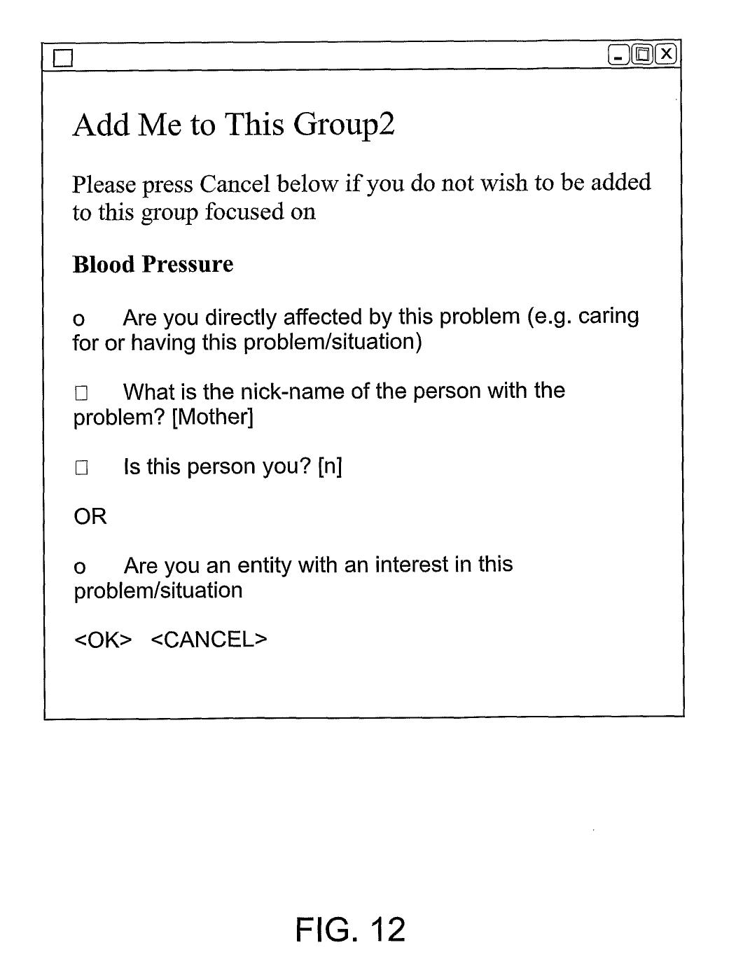

FIG. 10 is a screen shot of a web page that allows the user 23-n to join a problem group by clicking on a relevant subject area. Furthermore the user 23-n may add a new group by clicking on the “Add a NEW group” button. FIG. 11 is a screen shot of a web page that allows the user 23-n to create a new problem group. Once the user 23-n has selected a group to join, at FIG. 12 he or she is prompted to confirm that he or she wishes to join that group and to state whether he or she is the person with the problem, is affected by someone else with the problem or simply has an interest in the problem.

Groups can also be subdivided based on particular interests, or when a size of a group becomes unmanageable. Such subdivisions thus can be proposed by users or by a moderator. Further, as the number of users and complexity of a web site according to the present invention increases, relatively unrelated groups may start to congregate. For example, groups involved with non-medical technical problems may be interested in cross-group responses. Thus additional questions can be added to identify which ‘macro’ groups can act and cannot act as controls for particular questions.

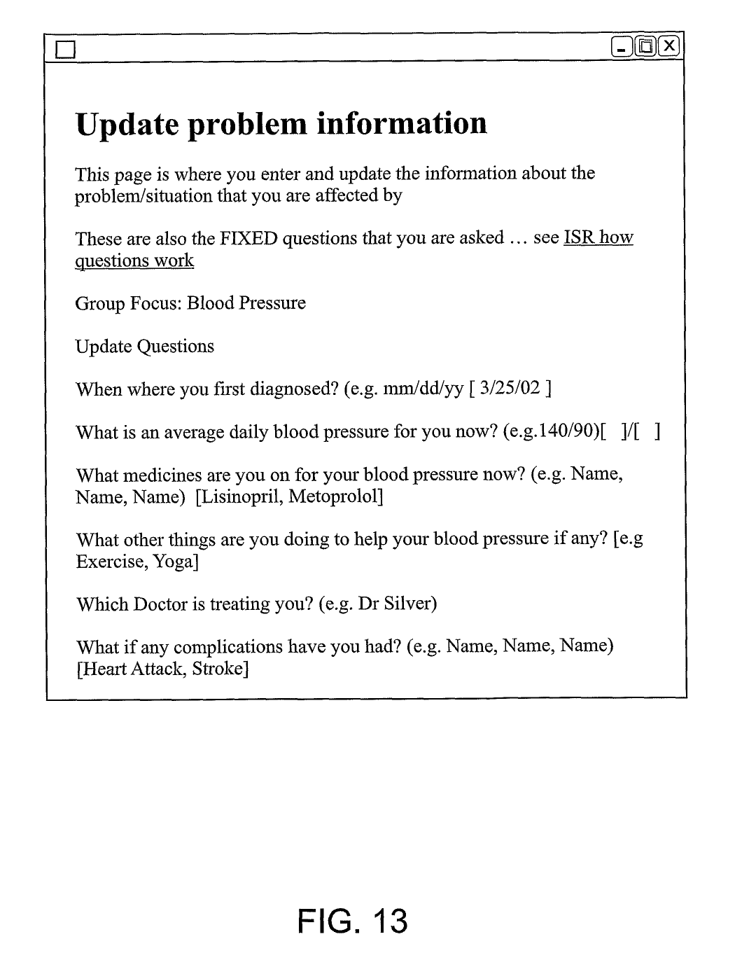

FIG. 13 is a screen shot of a web page where a user can review or answer fixed questions. For example, fixed questions concerning a medical issue may include the blood pressure, treating doctor, complications, and other specific questions that relate to the subject area of the group. Many of the fixed questions, for example blood pressure, should be asked periodically to provide statistical trends concerning the user 23-n. Fixed questions thus may be answered routinely, for example once a week, once a month or at any other applicable time interval, or when treatment changes are made for a particular condition. These questions generally do not change, but a group may propose to change them. The fixed questions allow the group to monitor what happens over time in terms of the severity of a problem and may also allow treatments to be monitored for efficacy and complications.

According to some embodiments of the present invention, a user may have a private problem (e.g., mouth ulcers, migraines or another personal ailment) that they do not want to share or discuss with a multi-user problem group. Nevertheless, the user may want to use the system of the present invention to assist him or her to determine what lifestyle choices (e.g., eating habits) make some days better than others. Therefore, in addition to the group interactions described herein, the server 22 enables the user to propose and respond to the user's own private questions that are not shared with a multi-user problem group, and the server 22 analyses the data and provides private statistical analyses to the user.

For example, a user may submit to the server 22 on a private basis various variables such as sleep times, food eaten, amount of liquids consumed, exercise performed, and how they feel, and the server 22 responds on a private basis with an analysis of associations and other statistical data as described herein. Further, such individual and private analyses can be completed in addition to a user's participation in a multi-user problem group as described herein. Thus a user may exploit ideas and questions received from a group when designing private questions for submission to the server 22.

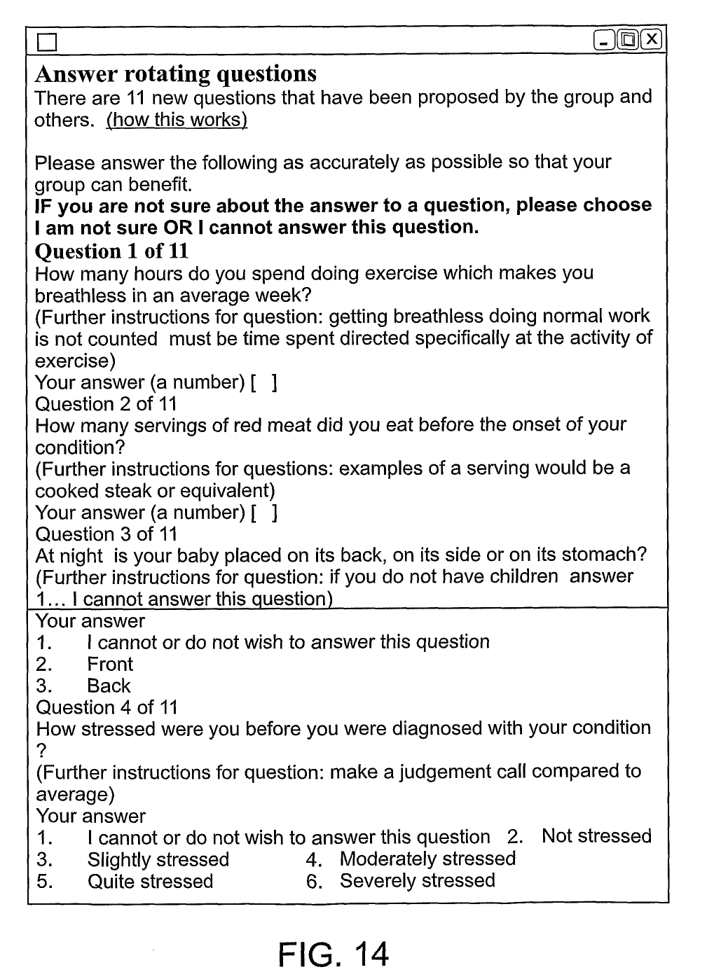

FIG. 14 is a screen shot of a web page where a user 23-n may input answers to rotating questions for a particular problem area. Rotating questions may include, for example, the number of hours of exercise per week, servings of red meat or the number of hours slept. These questions may be asked of one group within a particular problem area, or of all groups in a particular subject area. Answers to rotating questions also may be obtained from users 23-n from outside a group, such as where control answers are required. For example, a bowel cancer group may ask the question “How many servings of red meat did you tend to eat per week?” to users 23-n both inside and outside of their group. The group may then determine whether bowel cancer sufferers eat more or less red meat than the average person from other groups. If it turns out that users 23-n in the bowel cancer group do eat more red meat than users 23-n in other group, then one might determine that red meat is associated with bowel cancer.

It also can be important, according to some embodiments of the present invention, that users be able to properly remove themselves from a group. For example, if users abruptly leave a group without providing any reasons, other group members may be uncertain how contributions and answers previously provided by the removed group member should be managed. Thus when a user asks to be removed from a group he or she may be prompted to answer a question such as “Have you determined that you do not have the problem relevant to this group?” If the answer is yes, then data previously provided by the removed group member likely should not be used when determining relevant associations for the group. Further, group members may be prompted to provide contact information of a third party, such as an email address of a trusted family member or friend, who could be contacted by a group in the event that a user abruptly stops participating in a group. The third party could be contacted to learn, for example, whether a group member has died or whether there are other circumstances explaining a member's absence.

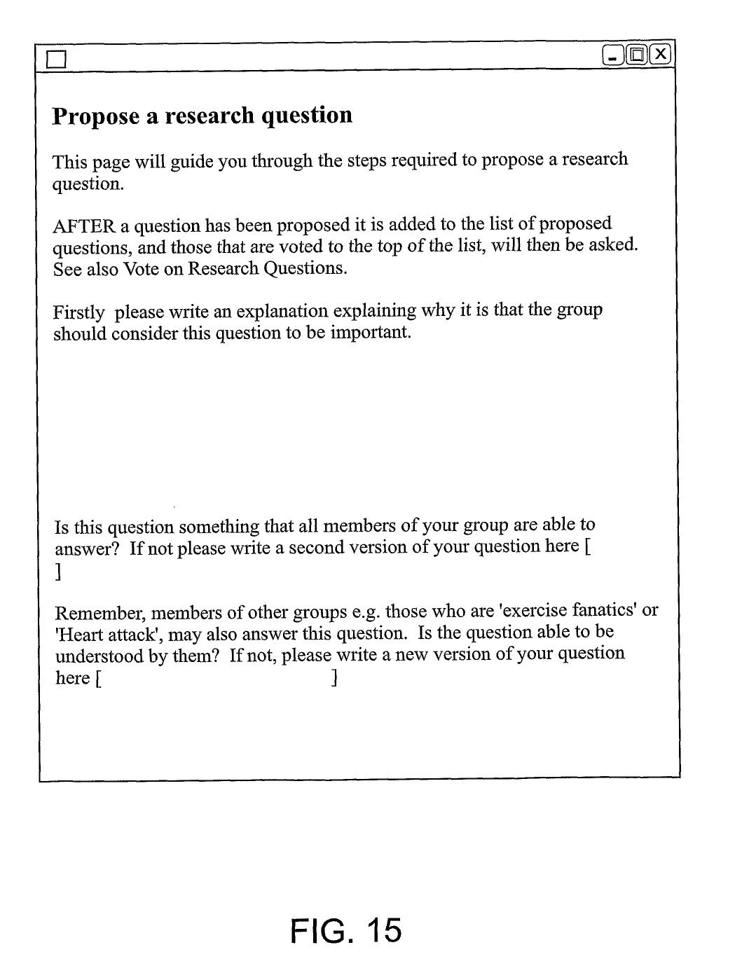

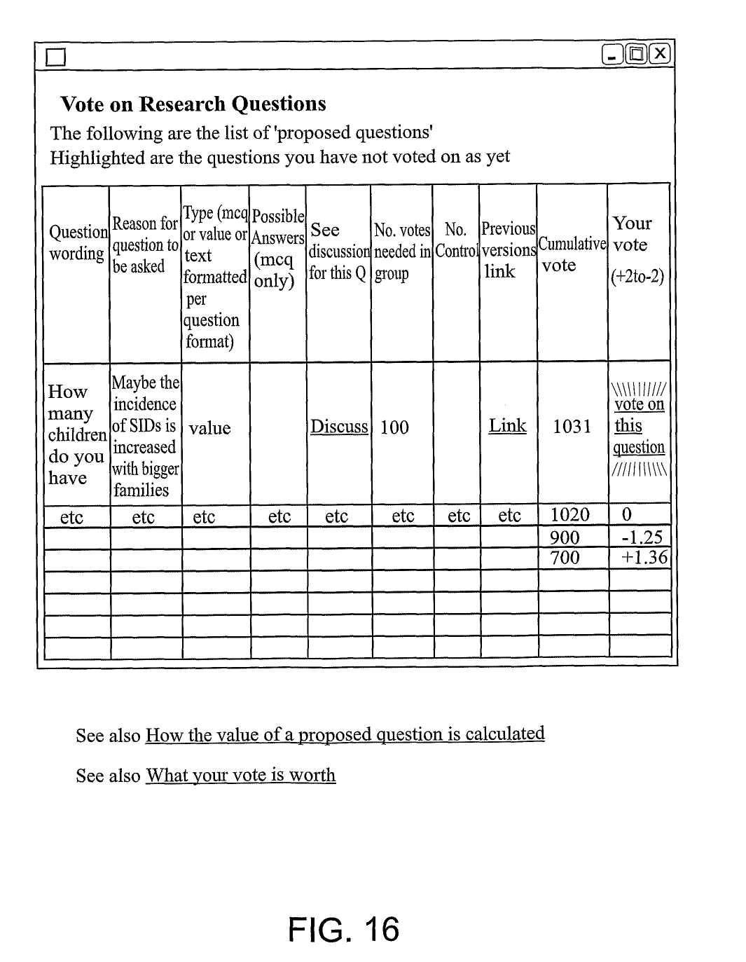

FIG. 15 is a screen shot of a web page that allows the user 23-n to ‘propose’ a research question. Research questions may be in the form of fixed questions or rotating questions. Additionally, the user 23-n may require questions to be asked outside the group, but within the same problem area, or to groups within another problem area that they feel is relevant. Questions asked outside the problem group are known as macro questions. Once the user 23-n has proposed a research question, other users 23-n may vote on that ‘proposed’ research question, as shown in FIG. 16. The ‘proposed’ research questions that receive the highest value of votes are likely to be added to the ‘actively asked’ questions lists. In the case of a rotating question, this is when a gap becomes available. In the case of a fixed question—when the voting total becomes high enough. Specifically with regards to rotating questions, when the ‘active’ rotating questions have been asked of a sufficient sample of group and control group members, they are rotated out of that list and are then replaced by the highest voted question in the ‘proposed’ rotating questions list. Proposed questions may be modified a number of times before the group actually likes them enough to vote them up to the top of the list, where they are then likely to become ‘active’ questions.

When a user attempts to enter a new question, it may be that the user may be proposing to add a new fixed or rotating question. Thus automated steps can be taken to ensure that users properly categorize their questions. For example, a user may be asked the following: “Is this question meant to be asked of users of this group ONLY?”.

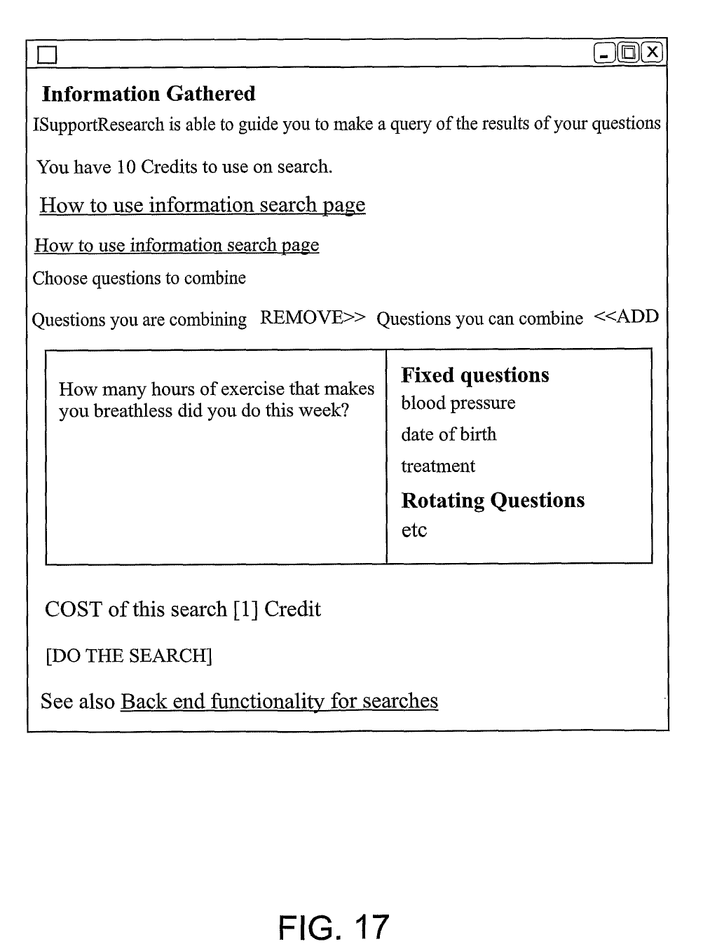

FIG. 17 is a screen shot of a web page that allows users to search for statistical relationships in data collected by a group. A user 23-n may select to view data on the user details, answers to fixed questions, or answers to rotating questions and combinations. The data to be combined, analysed and reviewed are selected from the desired categories in a category list. The server 22 processes the selections entered by the user 23-n and sends the data to the user 23-n. For example, as shown in the rectangle on the right side of FIG. 17, a user 23-n can select particular fixed or rotating questions that have already been asked of a multi-user problem group. The user 23-n can then “drag and drop” one or more questions into the rectangle on the left side of FIG. 17, such as the question “How many hours of exercise that makes you breathless did you do this week?”, to initiate an automatic generation of an identification of statistical information and associations concerning that question and other relevant data. Other relevant data may include other questions that are also dropped into the rectangle on the left side of FIG. 17. For example, a question concerning blood pressure can be added to the question concerning weekly hours of exercise to prompt the server 22 to investigate, based on existing answers to the above questions, whether statistically relevant associations exist between amounts of weekly exercise and blood pressure.

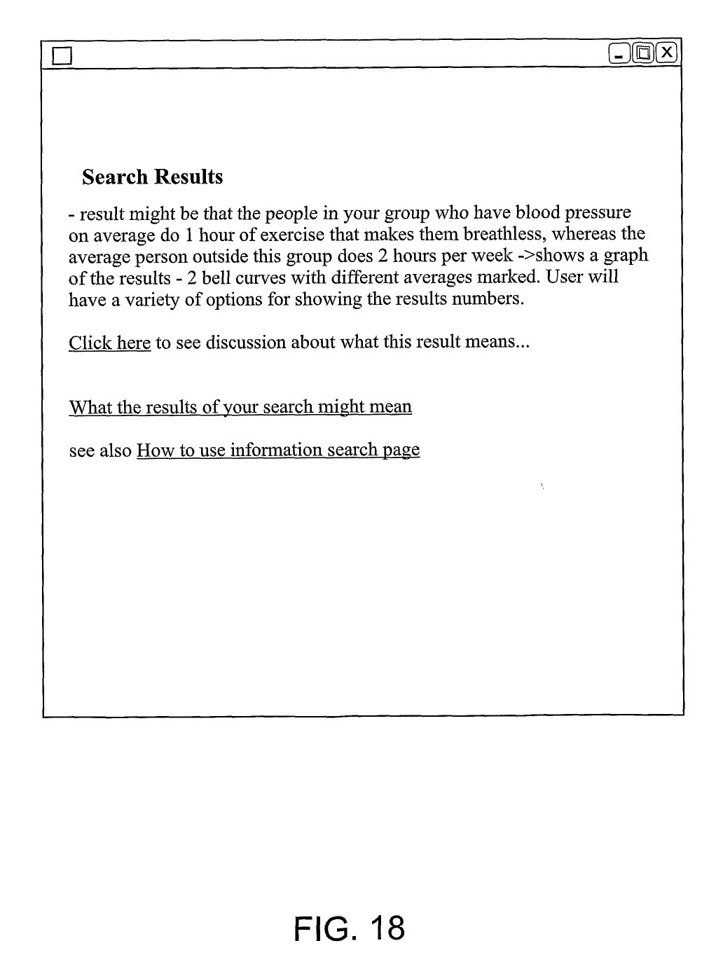

FIG. 18 is an incomplete screen shot of a web page that displays results of the data selected by the user. What is not seen is that the data may be displayed using various graphical aids such as tables, graphs, pie charts, or various other applicable presentation methods. This depends on the combinations of input variables selected (see the discussion of FIG. 17 above). Further, the data may be accompanied by an explanation as to what the results may mean, and a discussion by users about these results to date. Explanations may be given by a moderator, doctor or another professional working within a problem area.

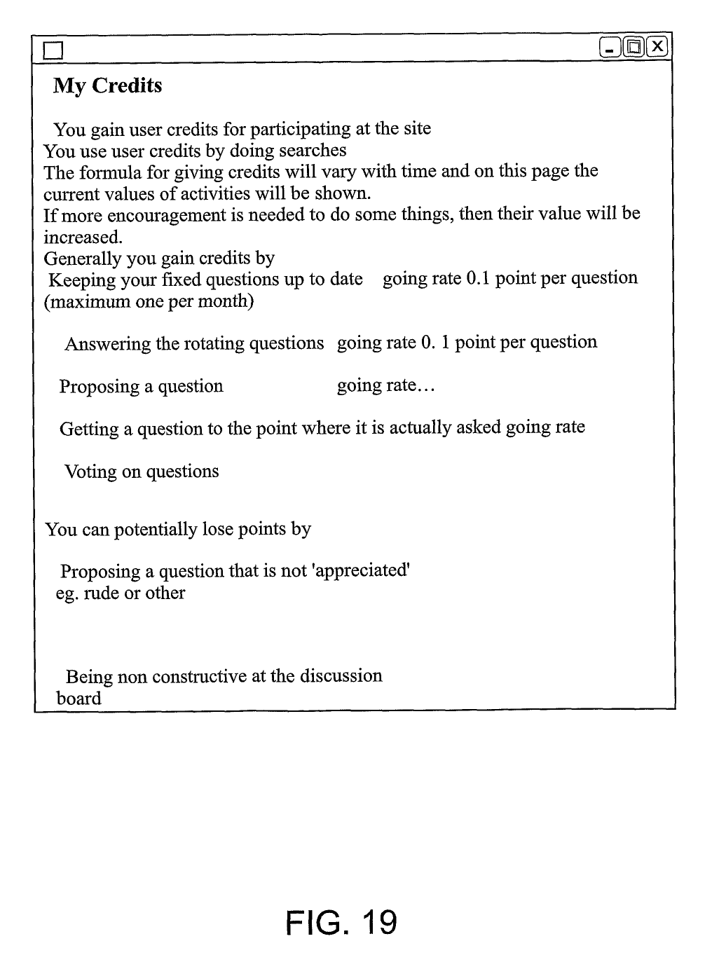

According to some embodiments of the present invention, it may be necessary to provide incentives for the users 23-n to answer all questions asked of them. Such incentives can be designed to discourage users 23-n from eliciting information from a group without properly and correctly answering questions authored by other group members. For example, such incentives may include a system of credits. By participating in research questions, users 23-n may earn credits that enable further group participation and obtaining of further research data. For example, FIG. 19 is a screen shot of a web page that allows the user 23-n to view a number of credits he or she has earned, used or purchased. Credits then may be used to view statistical data about a group. Alternatively, any interested user 23-n who is not actively participating in research may purchase credits in order to view research data. Ultimately it will be important to decide on combinations of incentives to make sure the people who do answer questions are motivated to answer them correctly. Further, the server 22 may transmit periodic emails to users to remind the users to answer questions.

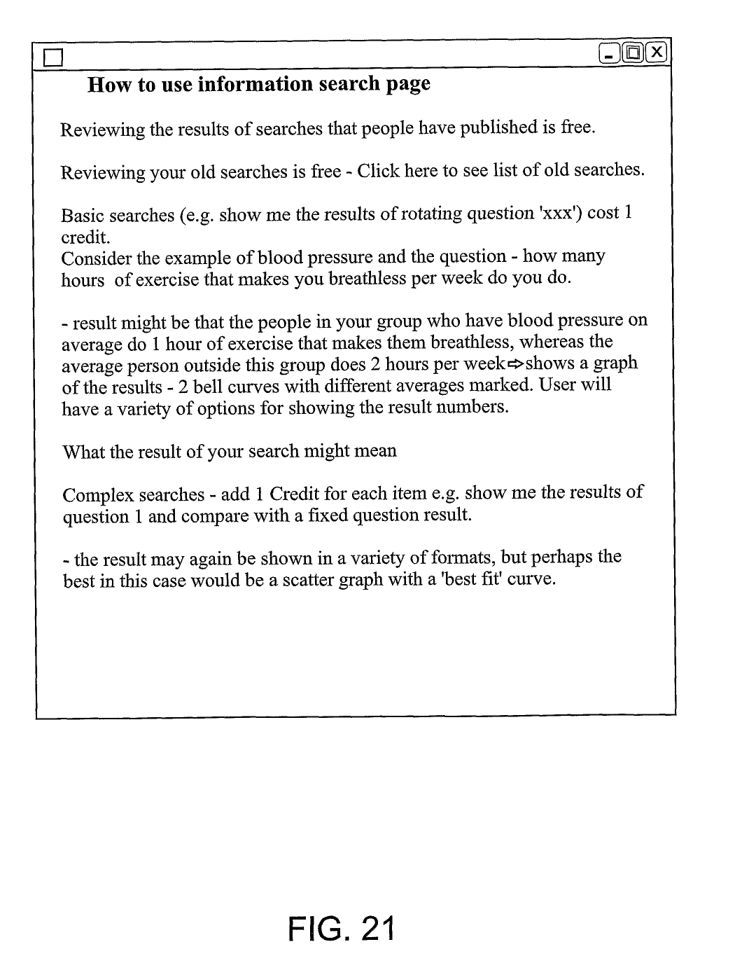

Finally, FIG. 21 is a screen shot of a web page explaining how to use the information displayed by a system and method for conducting on-line research, according to some embodiments of the present invention.

In summary, embodiments of the present invention can empower people most interested in a disease, and who live it most dramatically (i.e., those affected by it), to work proactively and collaboratively toward identifying relevant associations and ultimately ‘solving’ a given disease's complexities, without needing to wait for some researcher attached to some group to come along and do similar research work. Further, although this specification has described in detail an embodiment of the present invention concerning medical problems, those skilled in the art will appreciate that a system of the present invention can also operate to identify statistically relevant associations concerning problems in non-medical fields. For example, computer users, vehicle owners, technical device users, pet owners, and parents can, using a system similar to that described herein, form various on-line problem groups and author questions. The answers to such questions provided by other group members then can assist in the automatic identification of associations relevant to the problem groups. Because such problem groups can be formed via the Internet, relatively large groups of users can be formed concerning generally rare problems. That can result in a statistically relevant number of answers being available for analysis, which can lead to the identification of otherwise difficult to identify associations.

In this patent specification, adjectives such as first and second, left and right, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A system for conducting on-line research involving identification of associations among data self generated by a multi-user problem group, the system comprising:
a server processor; and
a server memory coupled to the server processor, wherein the server memory includes computer readable program code components configured to cause:
processing user details received from a plurality of users in the multi-user problem group;
processing at least one fixed question, generated by a user in the plurality of users, relevant to a problem addressed by the problem group;
transmitting to the plurality of users the at least one fixed question;
processing answers to the at least one fixed question received from users in the plurality of users;
processing at least one rotating question generated by a user in the plurality of users;
transmitting to the plurality of users the at least one rotating question;
processing answers to the at least one rotating question received from users in the plurality of users; and
automatically generating an identification of at least one association based on the user details, the answers to the at least one fixed question, and the answers to the at least one rotating question.

2. The system of claim 1, wherein the identification of the at least one association is generated automatically by the server using statistical analysis.

3. The system of claim 1, wherein the plurality of users in the multi-user problem group is operatively connected to the server via the Internet.

4. The system of claim 1, wherein processing the at least one fixed question comprises enabling the plurality of users to vote on whether the fixed question is appropriate for the problem group.

5. The system of claim 1, wherein processing the at least one rotating question comprises enabling the plurality of users to vote on whether the rotating question is appropriate for the problem group.

6. The system of claim 1, wherein the user details comprise a user name, a date of birth, an email address, and a geographical indicator.

7. The system of claim 1, wherein a user earns credit for providing an answer to a fixed question or providing an answer to a rotating question.

8. The system of claim 1, wherein the at least one fixed or rotating question is authored by an expert in a field of the problem addressed by the problem group.

9. The system of claim 1, wherein the system processes, transmits and analyses answers to private questions submitted by a user that are not shared with the multi-user problem group.

10. The system of claim 1, wherein the memory further comprises computer readable program code components configured to cause transmitting to a user in the multi-user problem group the identification of the at least one association.

11. The system of claim 1, wherein the memory further comprises computer readable program code components configured to cause:
processing at least one control question generated by the multi-user problem group functioning as a primary multi-user problem group, and answered by a second multi-user problem group functioning as a control multi-user problem group.

12. The system of claim 1, wherein the problem addressed by the multi-user problem group concerns epidemiology.

13. A method for conducting on-line research involving identification of associations generated by a server in response to input received from a multi-user problem group, the method comprising:
processing user details received from a plurality of users in the multi-user problem group;
processing at least one fixed question, generated by a user in the plurality of users, relevant to a problem addressed by the problem group;
transmitting to the plurality of users the at least one fixed question;
processing answers to the at least one fixed question received from users in the plurality of users;
processing at least one rotating question generated by a user in the plurality of users;
transmitting to the plurality of users the at least one rotating question;
processing answers to the at least one rotating question received from users in the plurality of users; and
automatically generating an identification of at least one association based on the user details, the answers to the at least one fixed question, and the answers to the at least one rotating question.

14. The method of claim 13, wherein the identification of the at least one association is generated automatically by the server using statistical analysis.

15. The method of claim 13, wherein the plurality of users in the multi-user problem group is operatively connected to the server via the Internet.

16. The method of claim 13, wherein processing the at least one fixed question comprises enabling the plurality of users to vote on whether the fixed question is appropriate for the problem group.

17. The method of claim 13, wherein processing the at least one rotating question comprises enabling the plurality of users to vote on whether the rotating question is appropriate for the problem group.

18. The method of claim 13, wherein the user details comprise a user name, a date of birth, an email address, and a geographical indicator.

19. The method of claim 13, wherein a user earns credit for providing an answer to a fixed question or providing an answer to a rotating question.

20. The method of claim 13, wherein the at least one fixed or rotating question is authored by an expert in a field of the problem addressed by the problem group.
